(19) United States
(12) Patent Application Publication
(10) Pub. No.: US 2007/0219293 A1
(43) Pub. Date: Sep. 20, 2007

(54) METHOD FOR THE PRODUCTION OF PLASTICS CONTAINING FILLERS

(75) Inventors: Stefan Kaskel, Dresden (DE); Ullrich Holle, Mulheim an der Ruhr (DE); Holger Althues, Dresden (DE); Regina Palkovits, Mullheim an der Ruhr (DE)

Correspondence Address: NORRIS, MCLAUGHLIN & MARCUS, P.A., 875 THIRD AVE, 18TH FLOOR, NEW YORK, NY, 10022, US

(73) Assignee: Studiengesellschaft Kohle mbH, Mulheim an der Ruhr (DE)

(21) Appl. No.: 10/595,472

(22) PCT Filed: Oct. 20, 2004
(86) PCT No.: PCT/DE04/02348

§ 371 Date: Apr. 21, 2006

(30) Foreign Application Priority Data
Oct. 22, 2003 (DE) 103 49 061.2

(51) Int. Cl. C08J 3/20

(52) U.S. Cl. 523/333

(57) ABSTRACT

A method for the production of plastics containing fillers is disclosed, in which a reactive precursor for the filler is mixed with the polymer precursor, the reactive precursor for the filler is converted into the filler and the polymer precursor is polymerized to form the plastic. The filler generated thus has a particle size in the nanometre range which are evenly distributed in the precursor and also in the finished plastic, such that the appearance of the plastic, for example, the transparency of the finished plastic, is not affected.

The present invention relates to a method for the production of plastics containing fillers, in particular it relates to a method for the production of transparent moldings containing fillers.

Inorganic fillers serve for changing or tailoring mechanical and chemical properties, for example for reducing the flammability of polymers and plastics. Transparent plastic could be modified to date without resulting in opacity of the plastic only with difficulty by means of inorganic fillers because inorganic particles having a diameter of >300 nm or aggregates of smaller particles lead to light scattering effects which cause opacity of the plastic. Small inorganic particles (<300 nm, nanoparticles) which are present separately from one another within the plastic lead only to slight scattering effects, so that the transparency of plastic is retained. The object of the present invention is the development of a method which can be generally used and which permits production of inorganic nanoparticles within plastics, the in situ generation within a microemulsion being used, in which the monomer required for the production of the plastic forms the oil phase of the microemulsion.

Inorganic fillers have long been used for modifying physical and chemical properties of plastics. Particularly in recent years, the integration of nanoparticulate fillers into plastic material has been increasingly investigated. A distinction can be made between two strategies:

1. production and isolation of nanoparticles and subsequent integration into the plastic. Production and integration are not carried out in parallel.

2. production of the nanoparticles within the polymer matrix by modifying the polymer, i.e. parallel production of particles and polymer.

The advantage of the first-mentioned procedure is that it is possible to rely on known production methods for the production of nanoparticles, such as the Aerosil method, sol-gel technique or the microemulsion method. In order to integrate them into plastics, the particle must be surface-modified, which in some cases leads to high costs if, for example, functionalized silanes are used. Furthermore, that the particles first have to be isolated is disadvantageous. Thus, the Aerosil method or the microemulsion method permits the production of inorganic nanoparticles, but subsequent isolation steps such as drying and thermal treatment in the case of the microemulsion method, lead to aggregates or sintering together of the primary particles, which complicates the dispersing of the particles in the organic matrix or even makes it impossible. In the second strategy, for example, functionalized monomers or block groups, such as POSS (polyhedral oligomeric silsesquioxane), which either are integrated as such into the polymer or are further reacted during the polymerization in a sol-gel reaction, are used, a homogeneous distribution of the inorganic phase being achieved by the spatial separation of the functionalized monomers. Preformed groups, such as POSS, are retained in the matrix but are very expensive and the size of the inorganic particle is only slightly variable. In the context of the invention strived for here, POSS groups are not nanoparticles but well defined molecular structural groups. The further reaction of functionalized structural groups or the combination of sol-gel process and polymerization lead to homogeneous distribution of the inorganic structural groups but the size of the resulting nanoparticle can be controlled only with difficulty. This strategy can lead to a distribution of the inorganic component at the molecular level or to uncontrolled crosslinking of the inorganic phase, which leads to larger agglomerates of nanoparticles up to phase separation. Homogeneous, molecular distribution of the inorganic component leads to transparent plastic glasses, but the inorganic components do not have the physical properties characteristic of inorganic nanoparticles and therefore do not permit the introduction of a function, such as, for example, luminescence in the case of semiconductors, which is characteristic of the inorganic bulk phase or the nanoparticle. On the other hand, the uncontrolled formation of aggregates or phase separation leads to opacity of the plastic so that transparent plastics cannot be obtained.

It was accordingly the object of the present invention to provide a method for the production of plastics containing fillers which does not have the abovementioned disadvantages. In particular, the method should permit the production of transparent plastic whose transparency is scarcely visibly reduced compared with the pure plastic by addition of the fillers.

The present invention accordingly relates to a method for the production of plastics containing fillers, which is characterized in that
a reactive precursor of the filler is mixed the polymer precursor,
the reactive precursor of the filler is converted into the filler and
the polymer precursor is polymerized to give the plastic.

In the method of the present invention the fillers are first formed in situ, preferably in the aqueous phase of a w/o microemulsion or miniemulsion. The fillers produced have a particle size in the nanometer range and are uniformly distributed in the precursor and hence also in the final plastic. The appearance of the final plastic, for example the transparency, is not impaired even in the case of relatively large layer thicknesses.

In a preferred embodiment of the present invention, the polymer precursor is present in a mini- or microemulsion. The micelles usually have a diameter of up to about 100 nm, preferably up to 50 nm, in particular up to 20 nm. Emulsions having larger micelles are less preferred since light scattering effects may occur. In this embodiment, the monomer forms the oil phase and is present therein. This emulsion can also be designated as an inverse emulsion since the main phase is formed by the oil phase and not, as otherwise in the case of emulsions, by the aqueous phase.

In this embodiment, the reactive precursor of the filler is mixed with the w/o microemulsion or miniemulsion of an aqueous polymer precursor or with a solution of the polymer precursor. The reactive precursor for the filler is present in the aqueous phase and preferably reacts with the water, for example by hydrolysis, or by a precipitation reaction with a compound, such as a salt, which is present in or fed to the aqueous phase, with formation of the filler. This embodiment has the advantage that the reactive precursor of the filler is uniformly distributed in the monomer and accordingly also in the end product.

In the context of the present invention, polymer precursor is to be understood as meaning liquid or soluble polymerizable monomers, oligomers or polymers which can be converted by customary polymerization reactions into the final polymer. Monomers and oligomers or, for the production of copolymers, mixtures of monomers and/or oligomers are preferably used. Particularly preferably used polymerization precursor are those which lead to transparent end products. Examples of suitable monomers are acrylic acid and derivatives thereof and salts thereof, methacrylic acid and salts thereof, styrene and alkenes, polyesters and polyesters precursors of polycarbonates, polyepoxides, ethylene-norbornene copolymers and any desired copolymers of the corresponding monomers.

The fillers are preferably selected from inorganic compounds, in particular from hydroxides, oxides, sulfides, phosphates, carbonates and fluorides, particularly preferably from Mg(OH)₂, Mg₆Al₂(OH)₁₆(CO₃), SiO₂, TiO₂, ZrO₂, BaTiO₃, PbZrO₃, LiNbO₃, zeolite, MgO, CaO, ZnO, Fe₃O₄, ZnS, CdS, CaCO₃, BaCO₃, CaSO₄, CaF₂ and BaF₂. However, it is also possible to use luminescent compounds, such as the abovementioned BaF₂, ZnO, ZnS. ZnSe, and CdS or Y₂O₃, YVO₄, Zn₂SiO₄, CaWO₄, MgSiO₃, SrAl₂O₄, Gd₂O₃S, La₂O₂S, BaFCl, LaOBr, Ca₁₀(PO₄)₆(F, Cl)₂, BaMg₂Al₆O₂₇, CeMgAl₁₁O₁₉ and the like. Owing to the general applicability of the method according to the invention, the inorganic component can be varied within wide limits. The particles preferably have a particle size in the nanometer range. In order to maintain the transparency of transparent plastics and to keep the light scattering effects due to the fillers as small as possible, the particle size of the fillers is preferably less than 300 nm, but as far as possible even smaller, preferably from 5 to 50 nm, with a narrow size distribution.

For carrying out the method in this embodiment, the microemulsion or miniemulsion is first prepared in a manner known per se from polymer precursor, water and a surfactant. Suitable surfactants are nonionic surfactants, e.g. ethoxylated fatty alcohols, and ionic surfactants or amphiphilic block copolymers. For better integration of the filler particles formed, polymerizable surfactants may also be used.

Owing to the generic character, the method is very generally applicable. It is not limited to certain monomers. By using different surfactants or block copolymers, a large number of polar and nonpolar polymer precursors can be used in the method according to the invention.

The reactive precursor of the filler is then added.

In a further embodiment of the present invention, the reactive precursor of the filler is mixed with the polymer precursor or with a solution of the polymer precursor in an organic solvent.

For example, alkoxides of the general composition M(OR)ₛ, (M=Al, Si, Ti, Zr, Zn, etc.) which, in the aqueous phase of the microemulsion, lead to the formation of the particles, for example by hydrolysis and condensation, are used for producing the inorganic solid particles. If the mixture of polymer precursor and reactive precursor of the filler is not present as an emulsion, the corresponding reaction component, e.g. water, can be used for the conversion to the filler. It is also possible to use mixtures of different compounds of the reactive precursor. Thus, different alkoxides, such as Si(OR)₄, Ti(OR)₄ etc., can be used.

In the method according to the invention, it is also possible to incorporate those fillers which are obtainable by precipitation reactions with the formation of sparingly soluble salts, such as, for example, ZnS, CdS, as are obtained by passing H₂S into the liquid polymer precursor, or carbonate, as are obtained by passing CO₂ into the liquid polymer precursor, phosphates, as are obtained by a precipitation reaction with soluble phosphates or phosphoric acid, fluorides, which can be obtained by a precipitation reaction, for example with NH₄F, and further salts which are obtainable in this manner. One of the cations or anions of the salt to be prepared can also be used as the opposite ion or an ionic surfactant. For the preparation of salts, it is also possible to use the two-emulsion technique. There, in each case one component of the reagents required for the precipitation is dissolved in the aqueous phase of w/o microemulsion whose oil phase consists of the corresponding monomer, and the components are reacted by combining the emulsions.

However, salts which lead to precipitation within the inverse micelles by reaction with a gas or a second microemulsion can also be dissolved within the aqueous phase of an emulsion.

The size of the particles can be controlled, in particular in emulsions, as by the water/surfactant ratio and the choice of the surfactant. This is important, for example, for controlling physical properties, such as luminescence, via size quantization and permits targeted adjustment of the color of a luminescent plastic glass. After production of the inorganic component, the monomer phase is polymerized and the particles which are present isolated from one another in the micelles are enclosed in the matrix.

In the following step of the method, the polymer precursor is polymerized in a manner known per se in the presence of the filler produced in situ. If the mixture to be polymerized is present as a w/o emulsion, the polymerization can be effected as mass polymerization. The mass polymerization is suitable for the production of articles having a relatively high layer thickness and also for the production of products having a complex structure.

For example, for the production of films, the polymerization can also be carried out as so-called solution polymerization, by diluting the polymer precursor in the oil phase with a suitable solvent and then polymerizing it. After removal of the solvent, the plastic containing the fillers can be obtained as a transparent film.

Depending on the chosen polymer precursor, any desired plastics containing fillers can be produced. The method according to the invention is particularly suitable for the production of transparent plastic glasses containing inorganic nanoparticles.

In a development of the present invention, the mixture obtained after production of the filler particles is introduced into a mold and polymerized in the mold.

For the production of coatings, for example on transparent discs/sheets, the mixture obtained after production of the filler particles is applied to the surface to be coated and is then polymerized.

### EXAMPLES

A Preparation of the Microemulsion

6.5 ml of methyl methacrylate and 0.48 ml of distilled water are initially taken. The surfactant Lutensol AO11 (2.03 g) is added with stirring until the emulsion becomes clear. 0.2% (0.018 g) of AIBN (azobisisobutyronitrile) is then added for the subsequent free radical polymerization. The transparent microemulsion is homogenized for a further 10 min with stirring.

B Production of the Inorganic Nanoparticles in the Microemulsion and Polymerization

2.7 ml of a mixture of 50% of tetraethyl orthosilicate and 50% of methyl methacrylate are then added dropwise with stirring. The transparent emulsion is introduced into glass ampoules (d=10 mm), flashed with argon for degassing and sealed in under a slight vacuum. The polymerization is effected at 45° C. in a thermostated water bath in the course of 8 h hours, and the sample is cured for a further 3 h at 90° C. The product is a transparent polymer comprising MMA having a homogeneous distribution of SiO₂ particles of very narrow size distribution in the range of a few nanometers.

The electron micrograph of a microtome section of the plastic glass which is described in Example 1 and contains inorganic (SiO₂) nanoparticles is shown in the attached figure.

1. A method for the production of plastics containing fillers, comprising the steps of:
a) mixing a reactive precursor of the filler with a precursor of the plastic to form a mixture:
b) converting the reactive precursor of the filler in said mixture into the filler; and
c) polymerizing the precursor of the plastic in said mixture to give the plastic.

2. The method as claimed in claim 1, wherein the fillers are selected from inorganic compounds whose particle size is less than 300 nm, with a narrow size distribution.

3. The method as claimed in claim 1, wherein, the fillers are selected from the group consisting of oxides, sulfides, phosphates, carbonates, and fluorides.

4. The method as claimed in claim 1, wherein the polymer precursor is present in the oil phase of a w/o emulsion.

5. The method as claimed in claim 4, wherein the reactive precursor of the filler reacts with the, or in the, water present in the emulsion with formation of the filler.

6. The method as claimed in claim 1, wherein the polymerization of the polymer precursor is effected as mass polymerization.

7. The method as claimed in claim 1, wherein the plastic is selected from the group consisting of transparent plastics.

8. The method as claimed in claim 1, which is carried out for the production of transparent moldings.

9. The method as claimed in claim 1, which is carried out for the production of transparent coatings on surfaces.

10. The method as claimed in claim 3, wherein the fillers are selected from the group consisting of Mg(OH)₂, Mg₆Al₂(OH)₁₆(CO₃), SiO₂, TiO₂, ZrO₂, BaTiO₃, PbZrO₃, LiNbO₃, zeolite, MgO, CaO, ZnO, Fe₃O₄, ZnS, CdS, CaCO₃, BaCO₃, CaSO₄, CaF₂ and BaF₂.

11. The method as claimed in claim 7, wherein the plastic is selected from the group consisting of transparent plastics based on polyacrylic acids and salts thereof, polymethacrylic acid and salts thereof, polystyrenes, polyolefins and copolymers of the above.
